(19) United States
(12) Patent Application Publication
(10) Pub. No.: US 2013/0163262 A1
(43) Pub. Date: Jun. 27, 2013

(54) LIGHT EMITTING DIODE (LED) LAMP ASSEMBLY

(71) Applicants: SUNG-HSIANG YANG, Chu-Nan (TW); WEI-CHUN YEH, Chu-Nan (TW); CHENG-CHAO CHAO, Chu-Nan (TW)

(72) Inventors: SUNG-HSIANG YANG, Chu-Nan (TW); WEI-CHUN YEH, Chu-Nan (TW); CHENG-CHAO CHAO, Chu-Nan (TW)

(73) Assignee: FOXSEMICON INTEGRATED TECHNOLOGY, INC., Chu-Nan (TW)

(21) Appl. No.: 13/433,202

(22) Filed: Mar. 28, 2012

(30) Foreign Application Priority Data
Dec. 27, 2011 (TW) 100148752

(51) Int. Cl. F21V 21/088

(52) U.S. Cl. 362/396

(57) ABSTRACT

A lamp assembly comprises a lamp body, a bracket, and a securing member. The lamp body comprises a leg. The lamp body is arranged on the bracket. The securing member is mounted on the bracket and capable of moving relative to the bracket to press or away from the leg of the lamp body to achieve an assembly of the lamp body to the bracket or a disassembly of the lamp body from the bracket. The lamp body includes a plurality of light emitting diodes as a light source.

### BACKGROUND

1. Technical Field

The present disclosure relates to light emitting diode (LED) lamp assemblies, more particularly, to an LED lamp assembly which can be easily assembled or disassembled.

2. Description of Related Art

Conventional LED lamp assembly includes a bracket and a lamp body mounted on the bracket. The lamp body defines a plurality of through holes therein. The bracket defines a plurality of mounting holes corresponding to the through holes.

Fasteners extend through the through holes of the lamp body and the mounting holes of the bracket and engage with a predetermined object such as a wall or a post to assemble the LED lamp assembly on the predetermined object. When the lamp body needs to be disassembled from the bracket for repair, the fasteners need to be disassembled from the predetermined object one by one, which is time-consuming and costly requirement.

What is needed, therefore, is an LED lamp assembly to overcome the described disadvantages.

### BRIEF DESCRIPTION OF THE DRAWINGS

FIG. 1 is an assembled view of an LED lamp assembly of a first embodiment of the present disclosure, wherein a lamp body of the LED lamp assembly is locked.

FIG. 2 is an exploded view of the LED lamp assembly of FIG. 1.

FIG. 3 is similar to FIG. 1, but the lamp body is unlocked.

FIG. 4 is an exploded view of an LED lamp assembly of a second embodiment of the present disclosure.

FIG. 5 is an enlarged view, showing a part of the LED lamp assembly of FIG. 4 in an assembled state.

### DETAILED DESCRIPTION

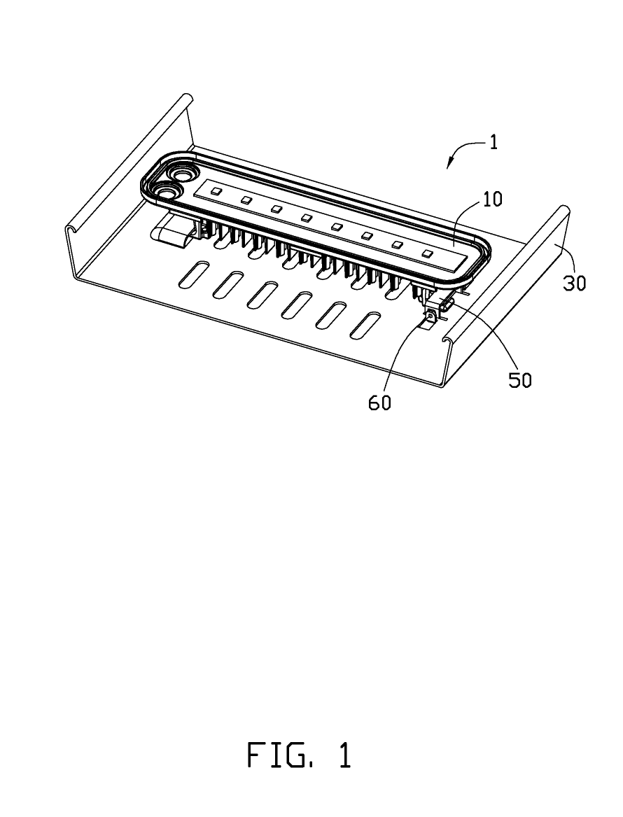

Referring to FIG. 1, an LED lamp assembly 1 according to a first embodiment is shown. The LED lamp assembly 1 includes a lamp body 10, a bracket 30 supporting the lamp body 10, and a securing member 50 moveably engaging with the bracket 30 to press a part of the lamp body 10 thereby securing the lamp body 10 to the bracket 30.

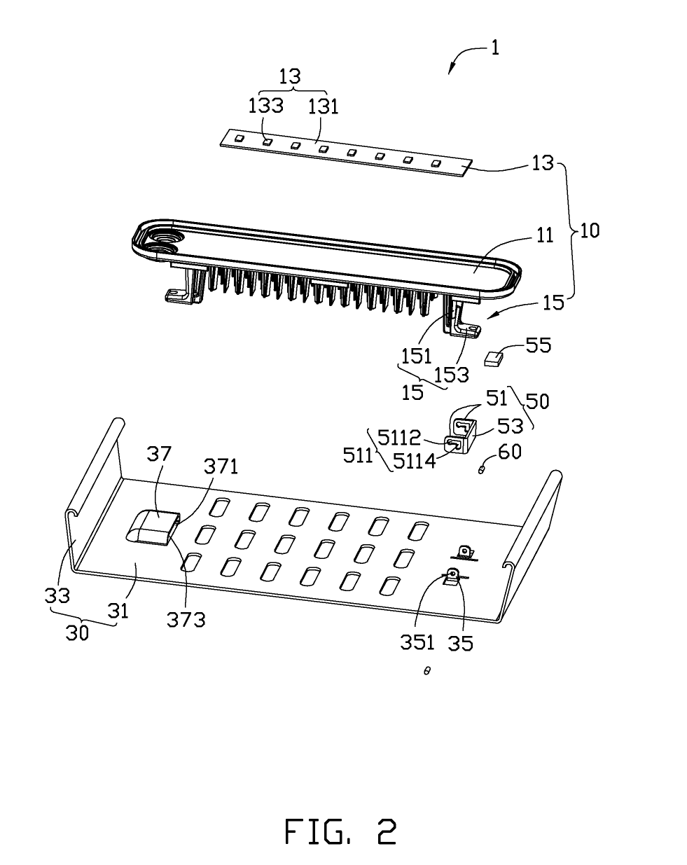

Referring also to FIG. 2, the lamp body 10 includes an elongated supporting plate 11, an LED module 13 mounted on a top surface of the supporting plate 11, two legs 15 respectively extending down from opposite ends of a bottom surface of the supporting plate 11, and a plurality of fins 17 extending down from the bottom surface of the supporting plate 11. The fins 17 are located between the two legs 15.

The LED module 13 includes an elongated printed circuit board 131 fixed on the top surface of the supporting plate 11 and a plurality of LEDs 133 mounted on the printed circuit board 131 along a longitudinal direction of the printed circuit board 131.

Each leg 15 includes an extending part 151 perpendicularly extending from the supporting plate 11 and a contacting part 153 bended from a bottom end of the extending part 151. The extending part 151 is elongated. The contacting part 153 is rectangular.

The bracket 30 includes an elongated bottom plate 31 and two sidewalls 33 extending upwardly from opposite ends of the bottom plate 31 and perpendicularly connecting the bottom plate 31. Two tabs 35 protrude from a top surface of one end of the bottom plate 31 (right end shown in FIG. 2). The tabs 35 are spaced from and face each other. A through hole 351 is defined in each tab 35. In this embodiment, the tab 35 is generally rectangular. An engaging plate 37 is formed on the other end (left end in FIG. 2) of the bottom plate 31. The engaging plate 37 is curved and edges thereof connect the top surface of the bottom plate 31. The engaging plate 37 and the bottom plate 31 cooperatively define a receiving chamber 373 therebetween with an opening 371 facing the right end of the bottom plate 31.

The securing member 50 is fixed on the tabs 35. The securing member 50 is generally U-shaped, and includes a rectangular pressing plate 53 and two connecting plates 51 perpendicularly extending from opposite ends of the pressing plate 53. Each connecting plate 51 is rectangular with a guiding groove 511 defined therein. A distance between outer surfaces of the connecting plates 51 is equal to or slightly less than that between inner surfaces of the tabs 35 of the bracket 30. In this embodiment, the guiding groove 511 is L-shaped and includes a straight first groove 5112 extending along a longitudinal direction of the connecting plate 51 and a straight second groove 5114 perpendicularly and downwardly extending from a top end of the first groove 5112, as viewed from FIG. 2.

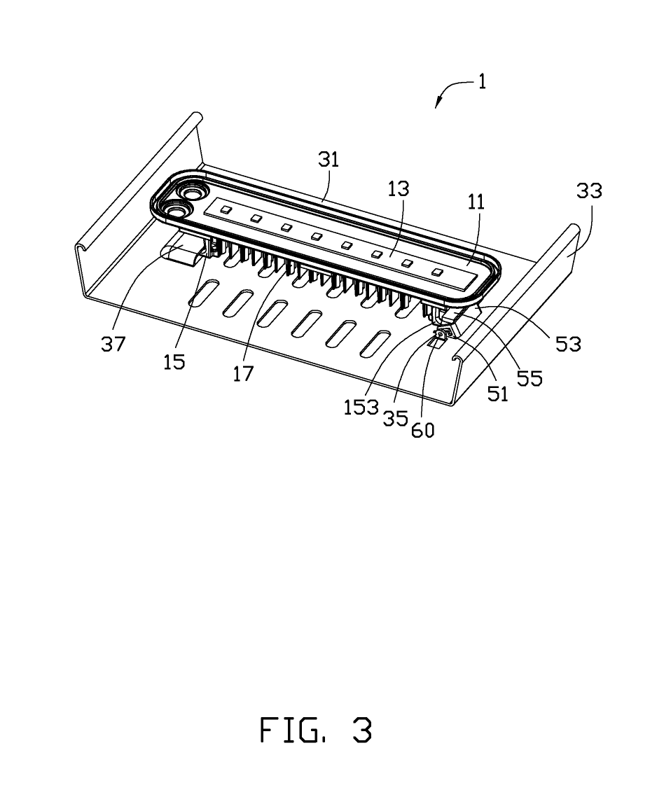

Referring also to FIG. 3, the securing member 50 is arranged between the tabs 35 of the bracket 30 with the pressing plate 53 at the right side of the tabs 35. The first grooves 5112 of the securing member 50 are aligned with the through holes 351 of the tabs 35, respectively. Two pins 60 extend through the through holes 351 and the first grooves 5112 to assemble the securing member 50 and the bracket 30 together.

The lamp body 10 is arranged on the bottom plate 31 of the bracket 30. The contacting part 153 of the leg 15 at the left end of the lamp body 10 is inserted in the receiving chamber 373 through the opening 371, and the contacting part 153 of the leg 15 at the right end of the lamp body 10 is arranged between the tabs 35. Referring again to FIG. 1, the securing member 50 is then operated to rotate about the pins 60 to make the pressing plate 53 of the securing member 50 positioned above the contacting part 153. In this state, the pressing plate 53 is spaced from the extending part 151, and the pins 60 are located at the lowest ends of the first grooves 5112, respectively. Then an elastic pad 55 is inserted between the contacting part 153 and the pressing plate 53. Thereafter, the pressing plate 53 is pushed downwardly towards the contacting part 153 until the pins 60 reach the intersections between the first grooves 5112 and the second grooves 5114, whereby the pressing plate 53 presses the elastic pad 55 downwardly against the contacting part 153. Finally, the securing member 50 is moved leftward until the pressing plate 53 abuts the extending part 151 and the pins 60 are located in the rightmost ends of the second grooves 5114, which are remote from the first grooves 5112. Therefore, the lamp body 10 is assembled on the bracket 30 completely and securely.

In disassembly, the above process is reversed. The securing member 50 is moved rightwards. The elastic pad 55 is then removed. Finally, the securing member 50 is rotated clockwise as viewed from FIG. 3 to leave the extending part 151.

In this embodiment, the lamp body 10 is secured to the bracket 30 without using any screws. The assembly and disassembly of the LED lamp assembly 1 can be easily achieved.

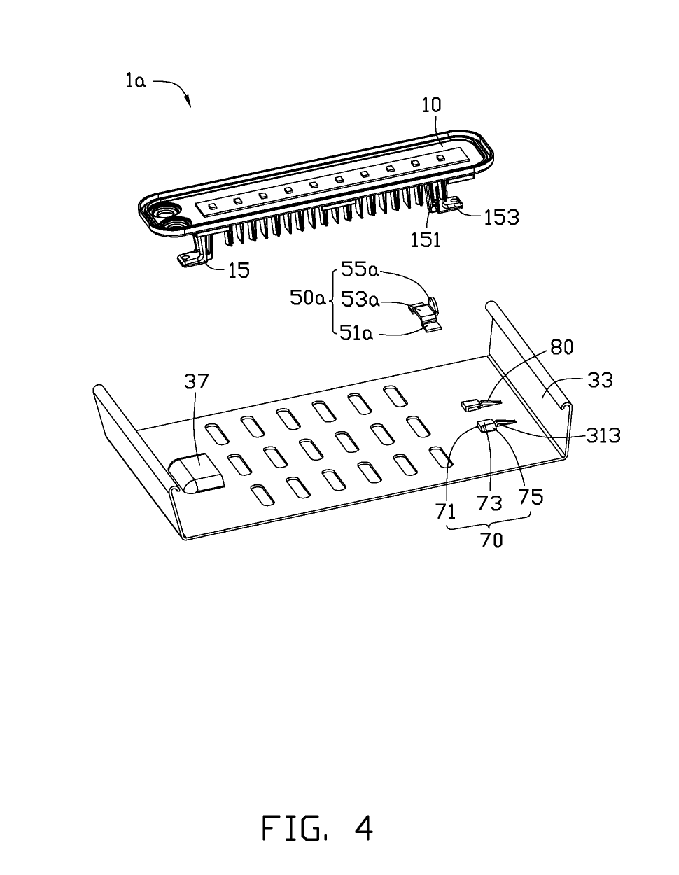

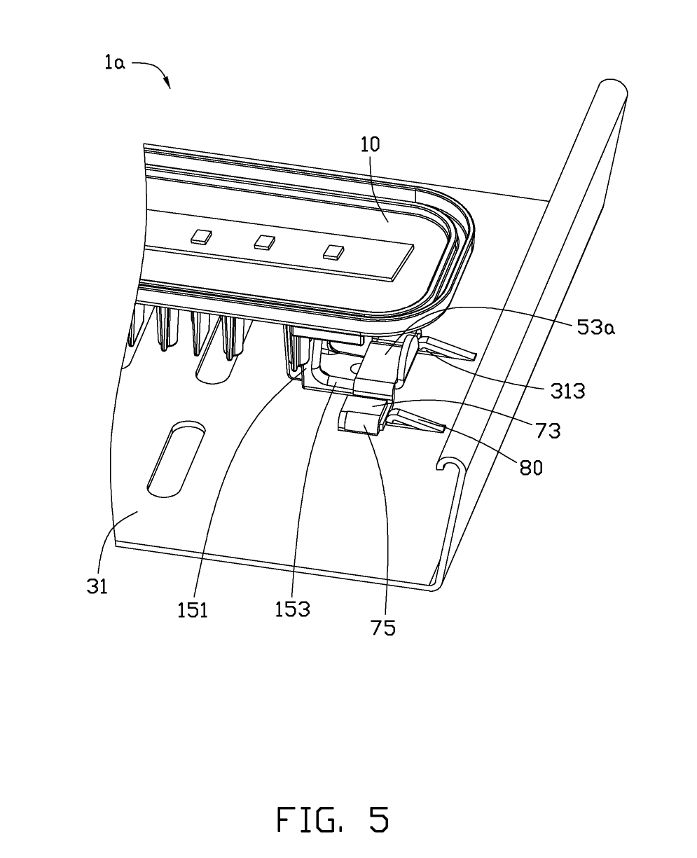

Referring to FIGS. 4-5, an LED lamp assembly la of a second embodiment is shown. In this embodiment, the securing member 50a is different from the securing member 50 of the first embodiment. The securing member 50a includes two spaced and parallel mounting plates 51a, a linking plate 53a located between and connecting with the mounting plates 51a, and a handle 55a extending upwardly from a right side of the linking plate 53a. Each mounting plate 51a is a rectangular sheet. The two mounting plates 51a are aligned with each other. The linking plate 53 is a U-shaped sheet and opposite ends thereof connect with the mounting plates 51a, respectively. The handle 55a is a semicircular sheet and located at a top of the mounting plate 51a for facilitating users to operate the securing member 50a.

Two spaced clips 70 are formed on the bottom plate 31 and engage with the securing member 50a. Each clip 70 includes a rectangular connecting sheet 71 extending upwardly from the top surface of the bottom plate 31, a rectangular extending sheet 73 bended rightward from a top end of the connecting sheet 71, and an arc-shaped restricting sheet 75 extending downwardly from an outer side of the extending sheet 73. The extending sheet 73 is parallel to the bottom plate 31. The restricting sheet 75 is convex. The largest distance between the two restricting sheets 75 is slightly larger than or equal to a distance between outer edges of the mounting plates 51a.

Two elastic arms 80 protrude from the top surface of the bottom plate 31 and between the clips 70 and the right sidewall 33. The elastic arms 80 are aligned with the clips 70, respectively. A rightmost end of the elastic arm 80 is away from the clip 70 and connects the bottom plate 31, and the other part thereof is spaced from the bottom plate 31 and located over a top of the bottom plate 31. A distance between a bottom surface of the elastic arm 80 and the top surface of the bottom plate 31 generally gradually increases from right to left. A left end of the elastic arm 80 which is adjacent to a right end of the clip 70 is slightly bended towards the bottom plate 31 of the bracket 30. A slit 313 is defined in the bottom plate 31 and below the elastic arm 80 to receive the elastic arm 80 therein when the elastic arm 80 is pressed.

When the lamp body 10 is assembled on the bracket 30, the left leg 15 engages with the engaging plate 37, firstly. The contacting part 153 of the right leg 15 contacts the top surface of the bottom plate 31 and is located between the two clips 70. Then the securing member 50a is assembled to the bracket 30 to press the contacting portion 153 of the right leg 15. The mounting plates 51a are arranged on the elastic arms 80. The securing member 50a is pressed downwardly and slides along the elastic arms 80 in a direction parallel to the bottom plate 31 until the mounting plates 51a are inserted in the two clips 70, respectively. In this state, right and left ends of each mounting plate 51a respectively abut the connecting sheet 71 and the left end of the corresponding elastic arm 80, and a lateral side of each mounting plate 51a abuts the corresponding restricting sheet 75. The linking sheet 53a presses the contacting part 153 of the right leg 15.

When the lamp body 10 is disassembled from the bracket 30, the elastic arms 80 are pressed toward the bottom plate 31 of the bracket 30, and the securing member 50a is pulled rightwards away from the clips 70 until the securing member 50a separates from the contacting part 153 of the right leg 15. Thereafter, the lamp body 10 is pulled rightward to be disassembled from the engaging plate 37. Thus, the lamp body 10 is disassembled from the bracket 30.

It is to be understood, however, that even though numerous characteristics and advantages of the embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A lamp assembly comprising:
a bracket;
a lamp body comprising a light source and a leg, the leg of the lamp body being configured for being secured to the bracket body thereby assembling the lamp body to the bracket; and
a securing member mounted on the bracket and being capable of moving relative to the bracket to press or separate from the leg of the lamp body, wherein when the securing member presses the leg, the lamp body is assembled to the bracket and wherein when the securing member is separated from the leg, the lamp body is capable of being disassembled from the bracket.

2. The lamp assembly of claim 1, wherein the leg comprises an extending part extending downwardly from the lamp body and a contacting part bended from a bottom end of the extending part, and the contacting part abuts against a plate of the bracket and is sandwiched between the bracket and the securing member when the securing member presses the leg.

3. The lamp assembly of claim 2, wherein the securing member moves perpendicularly relative to the plate of the bracket to press the contacting part.

4. The lamp assembly of claim 2, wherein the securing member comprises two connecting plates and a pressing plate between the connecting plates and connecting the connecting plates, a guiding groove is defined in each connecting plate, two tabs formed on the bracket, the connecting plates are located between the tabs, a through hole is defined in each tab, two pins respectively extend through the tabs and the guiding grooves of the connecting plates to assemble the securing member to the tabs, and the guiding groove is generally L-shaped.

5. The lamp assembly of claim 4, wherein the guiding groove comprises a first groove extending along a longitudinal direction of the connecting plate and a second groove bended from a top end of the first groove and communicating with the first groove, and wherein when the lamp body is assembled to the bracket, the pins are received in ends of the second grooves away from the first grooves of the connecting plates and the pressing plate abuts the extending part of the leg.

6. The lamp assembly of claim 4, wherein an elastic pad is sandwiched and compressed between the contacting part of the leg and the pressing plate.

7. The lamp assembly of claim 2, wherein another leg extends downwardly from the lamp body, and an engaging plate is formed on the bracket and engaging with the another leg.

8. The lamp assembly of claim 7, wherein the engaging plate and the bracket cooperatively define a receiving chamber therebetween, and the contacting part of the another leg is inserted into the receiving chamber and intimately engages with the engaging plate.

9. The lamp assembly of claim 1, wherein a plurality of fins is formed on the lamp body.

10. The lamp assembly of claim 1, wherein the lamp body comprises a supporting plate and an LED module mounted on a top surface of the supporting plate, and the leg extends from a bottom surface of the supporting plate.

11. The lamp assembly of claim 1, wherein the bracket comprises a bottom plate and two sidewalls extending upwardly from opposite ends of the bottom plate, and the lamp body is located between the sidewalls and arranged on the bottom plate.

12. The lamp assembly of claim 2, wherein the securing member comprises two spaced mounting plates and a linking plate located between and connecting the mounting plates, two clips are formed on the plate of the bracket, the mounting plates are inserted in the clips along a direction parallel to the plate, and the contacting part of the leg is sandwiched between the linking plate and the plate of the bracket.

13. The lamp assembly of claim 12, wherein each clip comprises a connecting sheet extending upwardly from the plate of the bracket, an extending sheet bended from a top end of the connecting sheet, and a restricting sheet extending downwardly from an outer side of the extending sheet, a corresponding mounting plate is located between the extending sheet and the plate of the bracket, a lateral side of the corresponding mounting plate abuts against the restricting plate, and an end of the corresponding mounting plate abuts against the connecting sheet.

14. The lamp assembly of claim 13, wherein two elastic arms protrude from the plate of the bracket and are located at a side of the clips, and the mounting plates abut against the elastic arms and slide along the elastic arms before the mounting plates are received in the clips.

15. The lamp assembly of claim 14, wherein an end of each of the elastic arms adjacent to a corresponding clip abuts an opposite end of the corresponding mounting plate.

16. The lamp assembly of claim 14, wherein the elastic arms are aligned with the clips, respectively.

17. The lamp assembly of claim 14, wherein an end of each of the elastic arms away from a corresponding clip connects with the plate of the bracket, and the other part of the elastic arm is spaced from the plate of the bracket.

18. The lamp assembly of claim 17, wherein a distance between a bottom surface of the each of the elastic arms and the plate of the bracket generally increases along a direction from the end of the each of the elastic arms connecting with the plate of the bracket toward the corresponding clip.

19. The lamp assembly of claim 18, wherein an end of each of the elastic arms adjacent to the corresponding clip is slightly bended towards the plate of the bracket.

20. The lamp assembly of claim 14, wherein a slit is defined in plate of the bracket and below each of the elastic arms to receive the each of the elastic arms therein when the elastic arms are pressed.
